(19) United States
(12) Patent Application Publication
(10) Pub. No.: US 2005/0001902 A1
(43) Pub. Date: Jan. 6, 2005

(54) Simplified user interface for an image capture device

(76) Inventors: Randall Brogan, Oviedo, FL (US); Gerald Angeli, N. Miami Beach, FL (US)

Correspondence Address: CONCORD CAMERA CORP., 4000 HOLLYWOOD BLVD, #650N, HOLLYWOOD, FL, 33021, US

(21) Appl. No.: 10/789,386

(22) Filed: Feb. 27, 2004

Related U.S. Application Data
(60) Provisional application No. 60/450,303, filed on Feb. 27, 2003.

(51) Int. Cl. H04N 5/225

(52) U.S. Cl. 348/207.1

(57) ABSTRACT

A simplified user interface is provided for transferring a captured image. Several steps requiring multiple user inputs have been simplified to occur in response to a single user input. Among other steps, the separate step of selecting the communication mode of the device prior to selection to transmit an image has been eliminated. Additionally, the separate steps requiring two user interactions of connecting to the device and transmitting to the device have been simplified into a single step.

### PRIORITY

The present application claims priority from co-pending provisional patent application Ser. No. 60/450,303, Filed on Feb. 22, 2003 and entitled SIMPLIFIED USER INTERFACE FOR AN IMAGE CAPTURE DEVICE.

### FIELD OF THE INVENTION

The present invention relates to the intra-device transmission of images and more particularly, to a simplified user interface for expediting the transmission of captured images.

### BACKGROUND OF THE INVENTION

Currently available devices equipped with BLUETOOTH radio transmission circuitry requires an additional step(s) to locate (discover) and connect with potential receiving devices and transmit to those devices.

What is needed is an image capture device that can transmit an image to one of a plurality of waiting devices with a minimum of user steps.

### SUMMARY OF THE INVENTION

A simplified user interface is provided for transferring a captured image. Several steps requiring multiple user inputs have been simplified to occur in response to a single user input. Among other steps, the separate step of selecting the communication mode of the device prior to selection to transmit an image has been eliminated.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood however, that the invention is not limited to the specific methods and instrumentality's disclosed. Additionally, like reference numerals represent like items throughout the drawings. In the drawings:

FIG. 1 is a front plan view of an image capture device in accordance with one particular embodiment of the present invention.

FIG. 2 is a rear plan view of an image capture device in accordance with one particular embodiment of the present invention.

FIG. 3 is a flow diagram contrasting the user taken steps with the algorithm driven device responsive actions taken in accordance with one particular embodiment of the present invention.

FIGS. 4-9 show the image capture device user display and user interface in accordance with one particular embodiment of the present invention.

FIG. 10 shows an image capture device user display and user interface in accordance with another embodiment of the present invention.

### DETAILED DESCRIPTION OF THE PREFERRED EMBODIMENTS

Before explaining the disclosed embodiments of the present invention in detail, it is to be understood that the invention is not limited in its application to the details of the particular arrangement shown since the invention is capable of other embodiments. Also, the terminology used herein is for the purpose of description and not of limitation.

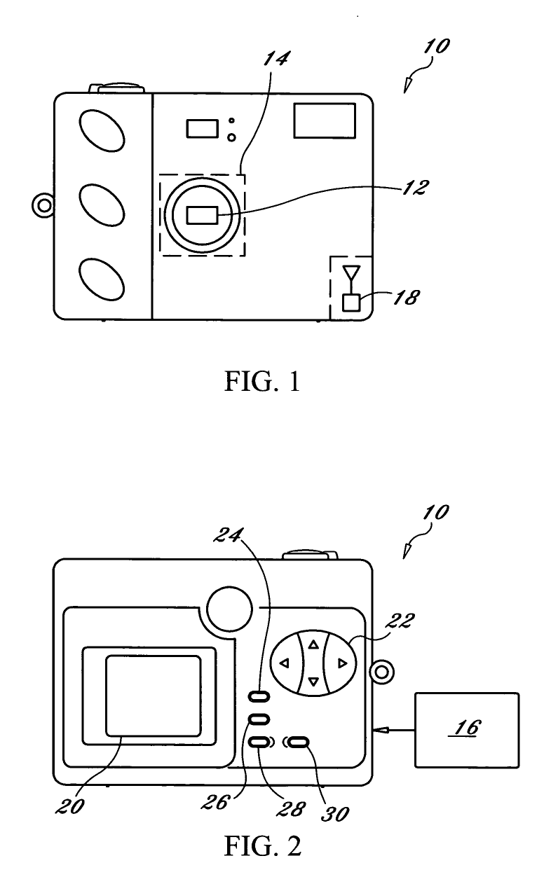

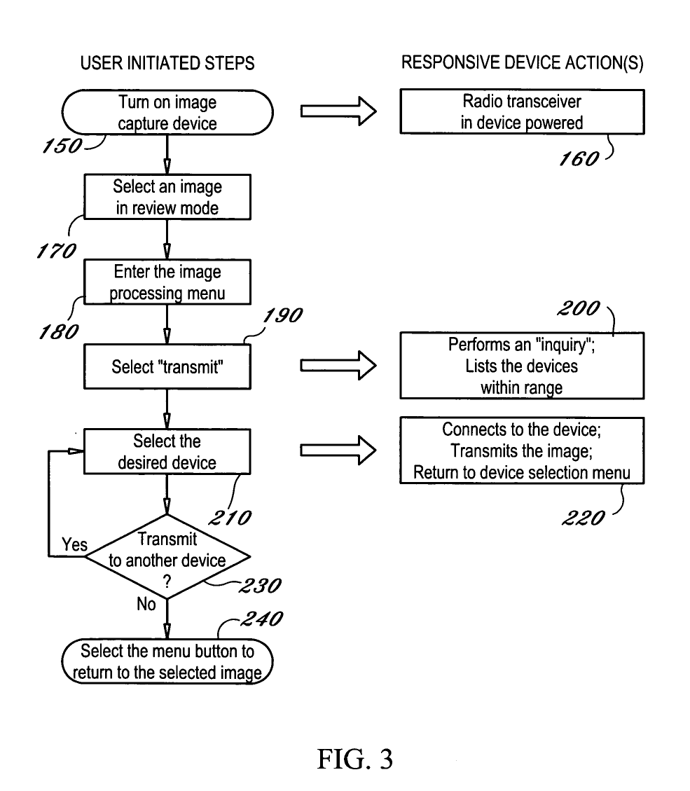

Referring now to FIGS. 1 and 2, there is shown one image capture device 10 with which the present invention may be used. Among other features, image capture device 10 includes a radio transmitter 18 and associated processing circuitry programmed in accordance with the BLUETOOTH standard initially developed by Ericsson, and presently maintained by the BLUETOOTH SIG, such as is covered by the BLUETOOTH SPECIFICATION ver. 1.1. The image capture device of the present invention is one that includes at least a lens 12 and image sensor 14 for digitally capturing an image, a memory 16 (which may be internal memory or a removable memory card, as shown) for storing an image or images, a radio transceiver 18 operational to at least transmit in accordance with the BLUETOOTH SPECIFICATION and, if desired, to receive in accordance with that specification, and an internal or external display 20 to assist a user in reviewing and selecting an image or images for transmission. Additionally, user interface buttons, such as four way directional button 22, power button 24, LCD button 26, menu button 28 and ok/select button 30, may additionally be provided. It can be seen that this is not meant to be limiting, as fewer or more buttons may additionally be provided, as desired.

Referring now to FIGS. 1-9, there will be described a device and method for facilitating transmission of an image to one of a plurality of BLUETOOTH enabled devices with a minimum of user interaction. At some time during the use of an image capture device, a user may desire to send the captured image to another device (i.e. a printer, a computer, an internet device, a cell phone a PDA, a handheld computing device). For example, a user may capture a scene or desire to transmit a scene previously captured to another device.

If the image capture device is not already turned on, the user must first turn on the image capture device. Step 150. In one particular embodiment of the present invention, turning on the image capture device 10 simultaneously powers on and initializes the BLUETOOTH radio transceiver 18 inside the image capture device. Step 160 of FIG. 7. In this manner the user does not have to separately turn on the radio transceiver 18, as is required in other devices.

Next, a photographic scene is selected from the image capture device memory 16. Step 170. In one particular embodiment, BLUETOOTH radio transceiver 18 can additionally receive images from other BLUETOOTH enabled devices. As such, the image selected from memory 16 may be an image captured by that image capture device 10, or may be an image previously uploaded to the image capture device memory from another image capture device or computing device. The selected image is displayed on the image capture device's display, which may be an LCD viewing panel 20, as shown.

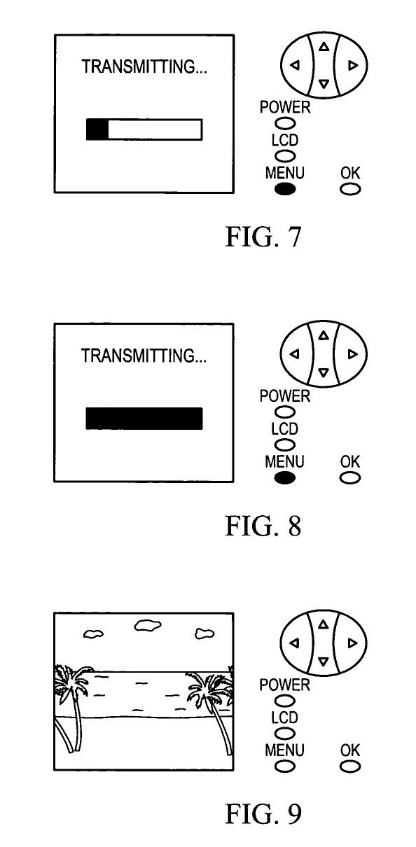

Once a particular image is selected, the image processing menu is entered (Step 180) by pressing the menu button 28. As shown more particularly in FIG. 4, the image processing menu 35 will be displayed on the display 20. At which point the four way directional button 22 may be used to select the “TRANSMIT” soft button from the menu display. Step 190. Once highlighted, the ok/select key 30 may be entered.

Upon selection of the “TRANSMIT” button from the menu, the BLUETOOTH radio transceiver is activated to perform an INQUIRY and NAME REQUEST of all BLUETOOTH receiving devices (e.g. cell phone, pda, printer, computer) within the device range (See FIG. 5). After which, as shown in FIG. 6, a list is automatically provided to the camera user on the LCD viewing panel. Step 200.

If no BLUETOOTH devices are found, the program may follow a pre-selected hierarchy to initiate a second discover mode for a non-BLUETOOTH device (i.e. IR or WIFI) before signaling the user that no devices were found with which to communicate. Such a hierarchy is disclosed in commonly assigned PCT Application No. PCT/US02/35818 published on May 22, 2003 under International Publication No. WO 03/043305 entitled IMAGE CAPTURE DEVICE WITH MULTIPLE PROTOCOL WIRELESS TRANSMISSION, that application being incorporated herein by reference.

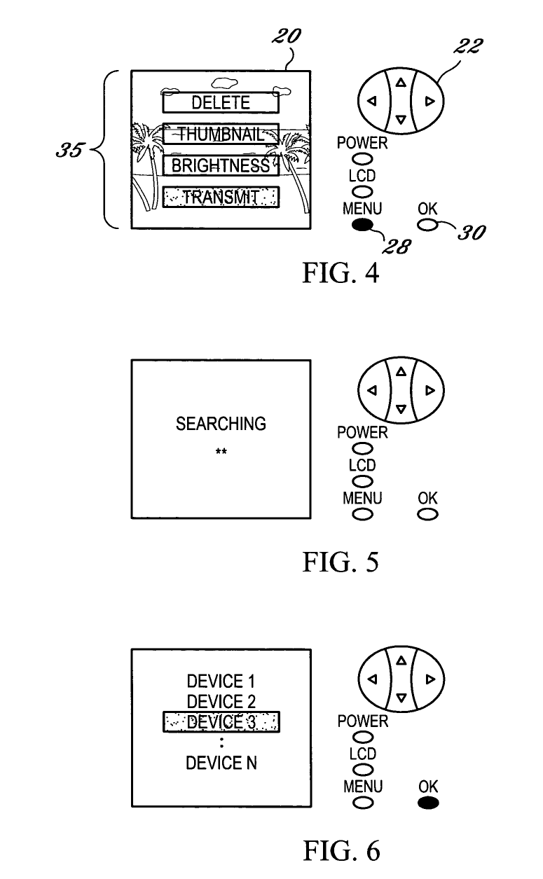

Note that in an alternate embodiment of the invention, the BLUETOOTH radio transceiver is not powered and initialized in step 160, as shown in FIG. 3, but rather, is powered and initialized, either when the image review mode is entered or in response to the “TRANSMIT” selection in step 200, wherein the radio transceiver goes on to transmit the INQUIRY.

Returning to the embodiment of FIGS. 3-9, the user selects the desired receiving device from the list using the four way directional button 22 and selects the ok/select button 30 to activate the transmission. Step 210. If desired, if only one BLUETOOTH enabled device is found, the camera may default to automatically transmit the image to that device and not present the user with a list of devices, thus eliminating Step 210.

In response to user selection of a device or default to a single located device, the device 10 connects to the selected device, transmits the selected image (FIG. 7) and auto-displays the status of the transmission and acknowledging the picture has been transmitted (FIG. 8), and returns the user to the device selection menu (FIG. 6) when transmission is complete. Step 220. In this way the user may select another device to which to transmit the selected image. If the user would like to transmit the image to another device, steps 210-230 are repeated. If the user would not like to transmit to another device, activating the menu button 28 returns the user to the selected image (FIG. 9). Step 240.

As can be seen from the description and drawings, the user interface of the present invention has been optimized to eliminate several user steps from the process of transmitting an image. Among other steps eliminated, the user does not need to separately turn on the BLUETOOTH transceiver or separately select the BLUETOOTH mode from a menu. Additionally, the user does not need to separately initiate a connection to the chosen device and select “transmit” again, after connecting to the device. Instead, it can be seen that simply powering on the image capture device 10 and selecting TRANSMIT once from the menu, automatically performs these additional steps that other systems require the user to perform.

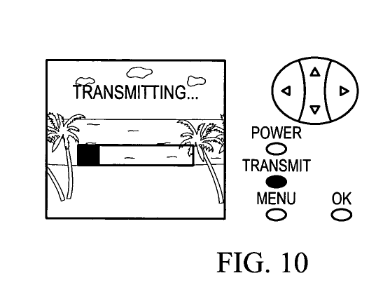

Referring now to FIG. 10, there is shown another embodiment of the present invention wherein the user interface includes a dedicated transmit button, which may replace the LCD function of button 26 of FIG. 2. In the present embodiment, the user selects the image to be transmitted on the display and selects the transmit button (as shown in FIG. 10) and in response to the depression of the TRANSMIT button, all of the following occurs: 1. The radio transceiver (18 of FIG. 1) is initialized, if it was not already done so when the device was turned on; 2. an INQUIRY and NAME REQUEST is performed, as shown in FIG. 5; and 3. A list of BLUETOOTH devices available within range are displayed or, if only one BLUETOOTH device is detected within range, the image is automatically transmitted to that device, by default, as shown in FIG. 10. In this embodiment, the steps of pulling up a menu and selecting TRANSMIT from a menu are eliminated in addition to the steps of choosing to initialize the transceiver and choosing the BLUETOOTH mode. As described above, setting the default to transmit automatically when only one local BLUETOOTH enabled device is located, further eliminates the step of choosing the device from a list, wherein the list only includes the one found device. As in the previous embodiment, if no BLUETOOTH devices are found, the program may follow a pre-selected hierarchy to initiate a second discover mode for a non-BLUETOOTH device (i.e. IR or WIFI) before signaling the user that no devices were found with which to communicate.

While the invention has been described with reference to certain embodiments, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of transmitting an image, comprising the steps of:
providing an image capture device including a radio transceiver that communicates wirelessly and directly with another local device, a display, a memory and a manual user interface;
initializing said radio transceiver;
selecting an image for transmission from said memory using said manual user interface;
selecting transmit using said manual user interface;
automatically performing an inquiry of devices within range of said radio transceiver in response to said selecting transmit step;
transmitting said selected image to at least one device found by said inquiry.

2. The method of claim 1, wherein said radio transceiver transmits in accordance with the BLUETOOTH specification.

3. The method of claim 2, wherein said initializing step occurs when power is first provided to said image capture device.

4. The method of claim 2, wherein said initializing step occurs in response to said selecting the transmit option step.

5. The method of claim 4, additionally including the steps of:
automatically listing on said display a list of devices found in response to said inquiry of devices, and
selecting a device from said listing using said manual user interface, and
wherein in response to said selecting a device step, said image capture device automatically connects with said device and transmits said image.

6. The method of claim 5, wherein transmit is selected in said selecting step from a menu displayed on said display using said manual user interface.

7. An image capture device, comprising:
a memory for storing a plurality of images;
a display upon which at least one image stored in memory can be displayed;
a manual user interface for selecting an image stored in said memory from said plurality of images;
a radio transceiver to communicate the selected image wirelessly and directly with another local device; and
wherein said manual user interface is used to initiate a transmit function of said image capture device, wherein said transmit function automatically performs an inquiry of devices within range of said radio transceiver.

8. The image capture device of claim 7, wherein said radio transceiver transmits in accordance with the BLUETOOTH specification.

9. The image capture device of claim 8, wherein said radio transceiver is initialized when power is first provided to said image capture device.

10. The image capture device of claim 8, wherein said transmit function additionally automatically initializes said radio transceiver.

11. The image capture device of claim 10, wherein a list of devices found in response to said inquiry of devices is presented on said display, and
said manual user interface is operable to select a device from said list of devices, and
wherein in response to selecting a device from said list, said image capture device automatically connects with said device and transmits said image.

12. The image capture device of claim 11, wherein the transmit option is selected from a menu displayed on said display using said manual user interface.

13. An image capture device, comprising:
a memory for storing a plurality of images;
a display upon which at least one image stored in memory can be displayed;
a manual user interface for selecting an image stored in said memory from said plurality of images;
a radio transceiver to communicate in accordance with the BLUETOOTH specification the selected image wirelessly and directly with another local device; and
wherein said manual user interface is used to initiate a transmit function, wherein the single action of initiating said transmit function, without any further action includes in serial order the following steps:
(a) initializing said radio transceiver for transmission;
(b) performing an inquiry of devices within range of said radio transceiver; and
(c) providing to the user on the display a list of devices found in response to said inquiry of devices, and
wherein said manual user interface is further operable to select a device from said list of devices, which selection causes said image capture device to automatically connect with said device and transmits said image.

14. The image capture device of claim 13, wherein the transmit function initiated from a menu displayed on said display using said manual user interface.

15. The image capture device of claim 14, wherein selecting a device from said list of devices additionally automatically returns to said displayed list of devices after said image is transmitted.
